(19) United States
(12) Patent Application Publication
(10) Pub. No.: US 2018/0319134 A1
(43) Pub. Date: Nov. 8, 2018

(54) NATURAL FIBER VENEER COMPOSITE MATERIAL

(71) Applicant: CleverOne Brands, LLC, Pleasant Prairie, WI (US)

(72) Inventors: Matthew Luciano Abbondanzio, San Diego, CA (US); Corey Canfield, Pleasant Prairie, WI (US); Diana Bagley, Milwaukee, WI (US)

(21) Appl. No.: 16/037,570

(22) Filed: Jul. 17, 2018

Related U.S. Application Data
(63) Continuation-in-part of application No. 15/337,059, filed on Oct. 28, 2016, now abandoned.
(60) Provisional application No. 62/236,106, filed on Oct. 30, 2015.

(51) Int. Cl. B32B 21/14; B32B 21/04; B32B 21/08; B32B 21/10; B32B 25/04; B32B 25/14; B32B 25/20; B32B 27/40; B32B 3/26; B32B 5/02; B32B 7/06; B32B 7/12; B32B 9/02

(52) U.S. Cl. CPC B32B 21/14; B32B 2317/02; B32B 21/08; B32B 21/10; B32B 25/04; B32B 25/14; B32B 25/20; B32B 27/40; B32B 3/266; B32B 5/022; B32B 7/06; B32B 7/12; B32B 9/02; B32B 2250/02; B32B 2262/02; B32B 2262/067; B32B 2307/546; B32B 2307/7265; B32B 21/045

(57) ABSTRACT

Example composite material devices, apparatus, articles of manufacture, and methods of manufacture are disclosed. An example composite material includes a first layer including a flexible veneer made of a natural fiber material; and a second layer including a flexible substrate, coupled to a first side of the first layer. The second layer is to support the first layer to be resistant to cutting and to be bendable up to 180 degrees to obtain a curvature without damaging the first layer or the second layer.

### RELATED APPLICATION

This patent arises from a continuation-in-part of U.S. patent application Ser. No. 15/337,059, which was filed on Oct. 28, 2016. U.S. patent application Ser. No. 15/337,059 is hereby incorporated herein by reference in its entirety. Priority to U.S. patent application Ser. No. 15/337,059 is hereby claimed. U.S. patent application Ser. No. 15/337,059 claims priority to U.S. Provisional Patent Application Ser. No. 62/236,106, which was filed on Oct. 30, 2015. U.S. Provisional Patent Application Ser. No. 62/236,106 is hereby incorporated herein by reference in its entirety.

### BACKGROUND

The statements in this section merely provide background information related to the disclosure and may not constitute prior art.

Safety and convenience are important aspects of food preparation. While current cutting boards may help with convenience, they typically do not satisfy safety concerns and may pose convenience limitations as well, resulting in a gap in consumer need compared to currently available options. For example, this identified gap in consumer need refers to the distance between consumers' desires to cut and prepare food for their meals on natural wood cutting boards and their need to keep themselves and their family safe from cross contamination that can occur with preparing certain foods such as poultry, meat etc. To mitigate this safety concern, consumers often use cutting boards and sheets made from plastic to prepare some or all of their foods as these plastic based products are often able to be placed in the dishwasher to be cleaned; a process that wood cutting boards typically are not able to be subjected to as a dishwasher will ruin them. Another advantage of plastic cutting sheets over solid wood cutting boards is that the plastic cutting sheets typically bend. The ability for sheets to bend and flex allows consumers to easily pour their cut food into pots, pans or other receptacles rather than having to lift a heavy board with one and scrape the cut food into the receptacle with a utensil or their other hand. This prior lifting process can be quite cumbersome and stressful on the user's wrist, as well as result in spills and inefficient transfer of items.

Despite advantages of plastic cutting boards and sheets over solid wood cutting boards, there remains the problem that the experience of using a plastic cutting board or sheet is often undesirable due to the overall user experience, aesthetics, etc. It has been found through ethnographic consumer research that cutting on plastic boards and sheets can be undesirable; the plastic can slip easily on a counter creating a potential danger and these plastic boards and sheets can become easily stained and warped over time. Through research it was found that the desire to use a wood cutting surface was so great that consumers will often prepare poultry and other potentially dangerous foods on their wood cutting boards and assume the risk that comes with hand washing these boards in their sink with soap and water. It should also be noted that this process of washing wood cutting boards, especially larger ones can be quite challenging as most boards do fit into typical sized sinks.

### BRIEF DESCRIPTION OF THE DRAWINGS

FIG. 1 illustrates partial view of the assembly of an example of a flexible veneer composite sheet with repositionable adhesive and a release liner.

FIG. 2 illustrates a partial view of an exploded view of an example of a flexible veneer composite sheet with repositionable adhesive and a release liner.

FIG. 3 illustrates a partial view of the assembly of an example of a flexible veneer composite sheet with a flexible substrate adhered to the second side of the veneer.

FIG. 4 illustrates a partial view of the assembly of an example a flexible durable veneer composite sheet and flexible substrate, coupled by an adhesive.

FIG. 5 illustrates a partial view of an exploded view of an example of a flexible durable veneer composite sheet and a flexible substrate, coupled by an adhesive.

FIG. 6 illustrates a partial view of the underside of FIG. 1 showing the use of a perforated release liner.

FIG. 7 illustrates an overview of a composite material cutting board.

FIG. 8 illustrates of an example composite material cutting board being bent to pour food.

FIG. 9 illustrates a flow diagram of an example method of manufacturing a cutting board such as shown in FIGS. 1-8.

FIG. 10 illustrates a flow diagram of an example method of manufacturing a cutting board such as shown in FIGS. 1-8.

The figures are not to scale. Instead, the thickness of the layers or regions may be enlarged in the drawings. In general, the same reference numbers will be used throughout the drawing(s) and accompanying written description to refer to the same or like parts. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. Stating that any part is in contact with another part means that there is no intermediate part between the two parts. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and/or other changes may be made without departing from the scope of the subject matter of this disclosure. The following detailed description is, therefore, provided to describe example implementations and not to be taken as limiting on the scope of the subject matter described in this disclosure. Certain features from different aspects of the following description may be combined to form yet new aspects of the subject matter discussed below.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

As used herein, the term composite material is used with reference to the coupling of a flexible veneer with a flexible substrate. In certain examples, an adhesive is used to couple the veneer and the substrate. The term composite material also can refer to a flexible veneer coupled with an adhesive, with or without the addition of a third layer including a release liner. For example, as used herein a veneer can refer to wood, bamboo, palm leaf, or similar natural fiber. As used herein, the term flexible substrate is used with reference to a variety of flexible materials including natural rubbers, synthetic rubbers, leathers, synthetic fabrics natural fabrics, and flexible metal. For example, as used herein an elastomeric rubber can refer to silicone, nitrile, neoprene, or similar polymer.

Certain examples described herein address deficiencies of a solid wooden cutting board and deficiencies of a flexible plastic cutting board. In certain examples, a flexible veneer is coupled with a flexible substrate. Certain examples can include a third layer (e.g., an adhesive) to bind the veneer and the flexible substrate together. In certain examples, a second side of a flexible veneer has a repositionable adhesive attached. In some such examples, an additional layer, including a release liner, is attached to an exposed side of the adhesive, where the release liner protects the adhesive until the material is ready for use. Flexibility of the composite material can depend on a variety of factors/properties including a durometer and/or thickness of the veneer and/or the flexible substrate.

As described further below, for a non-metallic substrate, as a thickness of the substrate decreases, a durometer of the substrate may increase. As the thickness of the substrate increases, the durometer of the substrate decreases. Such a thickness-durometer relationship allows for bending of the composite material without cracking, breaking, etc. (e.g., obtaining a one-inch diameter curvature without damaging any of the layers of the composite material, etc.). For a metallic substrate where bending memory is desired, the thickness of the substrate depends on its modulus of elasticity (e.g., Young's modulus). The lower the modulus of elasticity value, the thicker the material can be to achieve the same bending angle with the same force. For example, when static forming of the composite material is desired, a yield strength and ultimate strength of the material is taken into account along with a thickness of the material. The lower the yield strength, the thicker the metal can be given that a force to deform is still within the desired range. In addition, the wider the difference between the yield stress and ultimate stress of the metal material, the more effective the formable composite material is.

In certain examples, a composite material combines the convenience of a plastic cutting board with the luxury and cleanliness of a wood cutting board. While consumers prefer wood cutting boards and natural wood cutting boards cause less damage to knives than plastic cuttings boards, wood cutting boards can be damaged (e.g., cut, etc.) can harbor bacteria (e.g., in the cuts, wood grain, etc.). Additionally, plastic boards, even following a cycle through a dishwasher, have been proven to harbor bacteria.

A cutting board can be used in a variety of scenarios, including in the kitchen to prepare food or as a platter to serve food. Certain examples described herein provide a new composite material to be used as a cutting board, but which can be applied to many other consumer applications as well. The described composite material cutting board can be used to cut various foods, including meat, poultry, vegetables, fruits, etc. The flexible characteristics of the composite material allow for the cutting board to flex or roll into a funnel-like shape. This allows for easy lifting and pouring of the cut food into a receptacle, pan, sink, trash can, etc. In addition to the easy lifting and pouring of food by the cutting board, the flexibility of the composite material allows for the invention to conform to spaces smaller than the footprint of the cutting board. For example, if the cutting board is getting cleaned in a small sink, the cutting board can flex and bend so that it can more easily fit the sink and allow for more convenient cleaning. Similarly, the cutting board can be rolled into itself (e.g., approximately one inch diameter, etc.) to fit more comfortably in a drawer for storage.

In certain examples, the composite material includes two layers wherein a first layer includes a flexible veneer that is coupled to a second layer including a flexible substrate. The flexible veneer includes a natural material such as wood, bamboo, palm leaf, and/or other natural fiber. The veneer layer allows consumers to cut on a natural surface that is considered more luxurious than a plastic surface. The veneer is also manufactured to a thickness such that it has flexible characteristics (e.g., to be rolled into a diameter of approximately one inch without cracking or splitting, etc.). The second layer, including the flexible substrate, is coupled to a second side of the flexible veneer. The flexible substrate, in a similar manner to the veneer, has flexible characteristics. As a result, the entire composite material includes a first layer (a flexible veneer) and a second layer (a flexible substrate). Therefore, the composite material cutting board as a whole has flexible characteristics. The thickness of each layer can depend on the selection of materials. For example, a wood veneer layer can be between 0.01 inch and 0.075 inch to provide flexibility without enabling a knife to easily damage the wood (e.g., cut through the wood). A flexible non-metal substrate layer can be between a durometer of 60 Shore A with a thickness of 0.001 inch and a durometer of 40 Shore 00 with a thickness of 1 inch, for example. A flexible metal substrate can be between 0.0005 inch and 0.005 inch thick depending on a metal chosen, for example.

The second layer, including a flexible substrate, contributes many characteristic(s) that a veneer alone may not offer. In certain examples, the flexible substrate can act as a sealant relative to the veneer. For example, if the veneer does not have water resistant properties, a liquid may seep through the thin layer of the veneer and onto the surface below. Instead, the inclusion of the flexible substrate can block the seepage of the liquid through the veneer and prevent the liquid from causing a mess on the surface below the cutting board. In certain examples, the flexible substrate has a tacky, sticky, or slight adherence characteristic. During usage of the cutting board the tackiness can prevent the cutting board from sliding, creating a more stable and safe cutting board. Furthermore, certain flexible substrates are good insulators. This can allow the underside of the cutting board have high heat resistance. The composite material can be flipped upside down so that the second layer, the flexible substrate, faces upwards and can be used as a kitchen trivet, for example.

In certain examples, the composite material, including the veneer and the flexible substrate, can bend and flex up to 180 degrees provided that a diameter of the bend arc is an inch or more. The composite material can reach these flex parameters without cracking, delaminating, or failing due to veneer thinness and physical coupling of the veneer to the flexible substrate, for example. While thicker or thinner veneer can crack on its own, thinner veneer can be paired with a flexible substrate to enable the composite material can be bent in any direction, concave or convex, relative to the veneer layer.

Complete physical coupling of the veneer to the flexible substrate enables the composite material to bend (e.g., along a one-inch diameter curve, etc.) with the veneer following the same curvature of the flexible substrate to eliminate the ability for the veneer to crack along the grain when bent. However, areas of non-coupling or non-adhesion between the veneer and substrate bending occurs at different rates of curvature between the veneer and the substrate. The difference in curvature rates caused by the lack of physical coupling allows the veneer to bend at a sharp 90-degree angle, for example, which can cause the veneer to crack. The flexible composite material can give the cutting board unique properties and allow it to bend and pour cut food into various containers, pans, receptacles, etc. The composite material can also be rolled into itself for easier storage or flexed in a way to more readily fit into a sink for cleaning, for example, that the composite material may otherwise not have fit into.

In certain examples, the flexible veneer and the flexible substrate of the composite material can be coupled using an adhesive. The adhesive may be selected as determined by on the selection of the veneer and the substrate. The adhesive is chosen such that the flexibility of the composite material is not compromised. Instead, the adhesive ensures that the first layer (e.g., the veneer) and the second layer (e.g., the flexible substrate) do not delaminate when bending. The joining between the veneer layer and the substrate layer, and, as a result, a seam formed between the layers, is an important aspect for certain examples of the invention. For example, complete lamination ensures that the seam between the veneer layer and the substrate layer maintains its integrity, preventing a failure from compromising the composite material. Complete lamination may then force the veneer to follow the natural curvature of the substrate. For example, when the composite material is used to form a cutting board, after the cutting board has been used (e.g., to chop food, etc.), the cutting board can be cleaned in a kitchen sink, without the risk of water deforming the board or causing a failure at the seam.

In certain examples, the first layer (e.g., the veneer), and the second layer (e.g., the flexible substrate) can be coupled without the addition of an adhesive. The inclusion of the adhesive may depend on the material selections for the veneer and the flexible substrate. The absence or presence of the adhesive does not change the physical properties of the composite material cutting board. Absent the adhesive, the veneer and flexible substrate can be combined by in mold lamination. For example, the veneer is cut into shape and placed inside a mold. The substrate is then molded onto or around the veneer. This in mold lamination process can be used to incorporate labels, decals, and/or secondary parts into a composite molded product, for example. The molding process allows the substrate to penetrate a porous veneer to permanently attach the veneer to the substrate.

In certain examples, the second layer including the flexible substrate is excluded, leaving behind only the flexible veneer. As a replacement to the second layer, a first side of a repositionable adhesive is coupled to the flexible veneer. The repositionable adhesive allows the composite material to be repositionable such that the cutting board can be adhered to a first surface and be lifted and adhered to a second surface. The repositionable example of the described invention can be used numerous times by cleaning the veneer in a kitchen sink while keeping a consistent adhesiveness. For example, an acrylic-based adhesive, which is not water soluble, can be used, and, once the repositionable adhesive dries after washing, its adhesion properties return. Alternatively, the repositionable example can be disposed of after use. Without the inclusion of the flexible substrate, the described example maintains its flexible property.

In certain examples, a third layer is added to the example including the veneer and the repositionable adhesive. The third layer, including a release liner, is coupled to a second side of the repositionable adhesive (with the veneer coupled to a first side of the repositionable adhesive). The release liner can include paper and/or non-paper liners, for example. The release liner can include perforated cuts to allow sections of the release liner to be removed at a certain time and, as a result, cause sections of the repositionable adhesive to be exposed at a certain time, for example. Despite the repositionable adhesive being weak enough so that the cutting board can be repositioned to move cut food easily, the repositionable adhesive is strong enough to prevent the cutting board from sliding while cutting food. The lack of sliding creates a more stable and safe cutting board. This disposable veneer composite sheet can be used as a thin multi-use natural wood like cutting surface for food preparation. An adhesive, if used by the consumer, can keep the cutting sheet from moving (e.g., sliding) during use while still allowing the user to easily pick the sheet up to pour its contents and re-adhere it to a counter or other surface. This action is similar to a 3M Post-It™ note. The disposable veneer composite sheet can be used numerous times but can also be disposed of after any particular use, such as cutting chicken, to mitigate the chance of cross contamination of food borne illness such as salmonella. The disposal of the disposable veneer composite sheet is more likely to occur if the disposable veneer composite sheet is made of a renewable material such as bamboo, palm leaves, etc.

Depending on desired characteristics of the composite material (e.g., its use as a cutting board for certain food items, use with certain types of cutting instruments such as knives, pizza cutters, other blades, etc.), the veneer can be as thin as 0.01 inches, but can be as thick as 0.075 inches, for example. A thinner veneer can cause a knife to cut through the veneer layer while a thicker veneer can limit the flexibility of the composite material cutting board, for example. The selected thickness can depend on the selection of the flexible substrate. Both the veneer and the flexible substrate affect the flexibility of the composite material. For example, wood veneer thickness can be selected based on durability, flexibility (e.g., ability to flex without cracking), and/or cost.

Composite Material Examples with Flexible Veneer, Repositionable Adhesive, and Release Liner

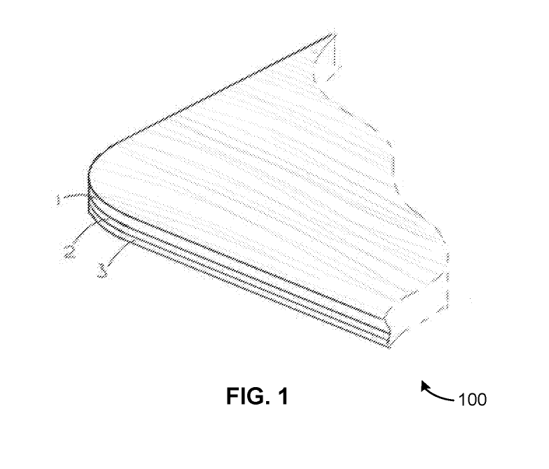

Turning now to the Figures, FIG. 1 illustrates a three-layered composite material 100 including a veneer 1, a repositionable adhesive 2, and a release liner 3. A first side of the veneer 1 can be used as a cutting surface while a second side of the veneer 1 can be coupled with a first side of the release liner 3 by the repositionable adhesive 2. In certain examples, the release liner 3 may not be included, and the composite material 100 then includes the veneer 1 and the repositionable adhesive 2. The repositionable adhesive 2 can removably adhere (e.g., be “tacky”) to a surface including that of metal, stone, wood, ceramic, plastic, or another similar material.

In certain examples, the adhesiveness of the repositionable adhesive 2 is similar to that of a 3M Post-It™ note. The adhesive 2 permits the flexible composite material 100 (e.g., implemented as a flexible cutting board) of FIG. 1 to be repositionable, in that the sheet of material 100 can be picked up and put down again on a surface such as a counter, etc., while maintaining its adhesiveness (e.g., maintaining 80-100% of original adhesiveness over a life of the composite cutting board device depending on cleanliness, care, etc.). The cutting board 100 is then prevented from sliding on the surface while in use. For example, the adhesive layer 2 provides sufficient grip on the surface on which the cutting board 100 rests so as to provide resistance to counter a force applied by an object (e.g., a knife, etc.) against the cutting board 100 and/or an item (e.g., a food item) resting on the cutting board 100.

In certain examples, the composite material 100 includes at least the veneer 1 and the repositionable adhesive 2 can be flexible in all directions, both concave and convex, such that the veneer 1 and the adhesive layer 2 will not crack or separate from each other. In certain examples, the composite material 100 can be flexible up to 180 degrees around a bend with a diameter of an inch without causing permanent flexural damage, including cracking or delamination. The flexibility of the cutting board 100 can be varied by the composition of the veneer 1 in part measured by the durometer of the material, as well as the thickness of the veneer 1.

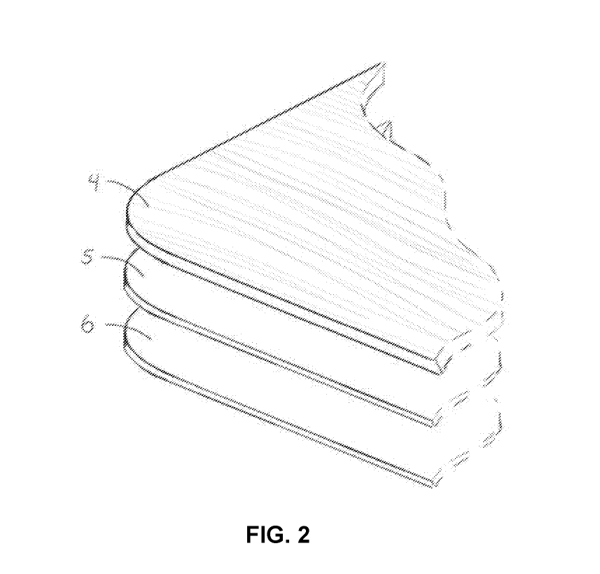

FIG. 2 illustrates an enlarged view of the composite material 100. In the enlarged view of FIG. 2, the disposable veneer 4, the repositionable adhesive 5, and the release liner 6 are shown. Three different substrates come together to form an example of the composite material 100 for the cutting board. In certain examples, a disposable veneer composite sheet 100 can be made by taking a thin natural veneer 4 and either applying a repositionable adhesive 5 to the back side of the veneer 4 using either spray method or by using a double sided pressure sensitive (PSA) adhesive where one side of the PSA, shown as the first side of the repositionable adhesive 5, permanently adheres to the natural veneer 4 and the other side of the PSA, shown as the second side of the repositionable adhesive 5, can temporarily, yet in a repeatable manner, adhere to a variety of surfaces such as ceramic, stone, metal, plastic etc.

Composite Material Examples with Flexible Veneer and Flexible Substrate

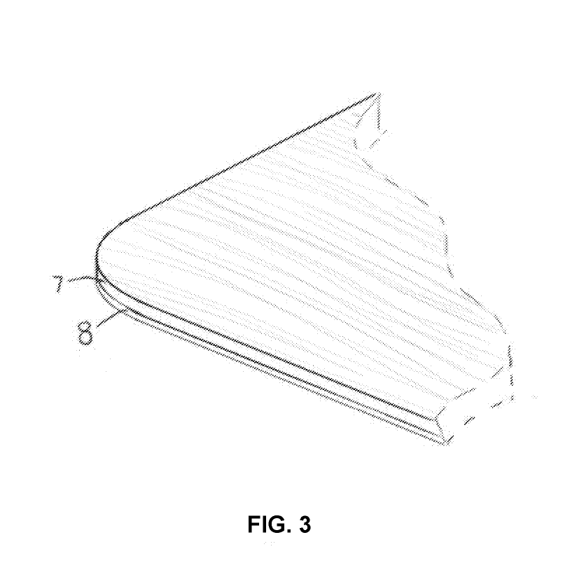

FIG. 3 illustrates an example of the composite material in which there is no adhesive. Instead, the veneer 7 and the flexible substrate 8 can be coupled together through other means (e.g., in-mold lamination, other fusing of materials, etc.) during the production process. Similar to the previous example shown in FIG. 0.1 and FIG. 2, the example of FIG. 3 maintains the flexible characteristic. Additionally, the flexible substrate 8 acts as a sealant for the veneer 7. The flexible substrate 8 is dense enough such that when pressure is applied to the composite material, for example when using a knife to cut food, the composite material upholds a rigid flat shape and does not bend in a manner that may cause flexural damage to the veneer 7. Without the flexible substrate 8, the veneer 7 may not have a rigid structure, causing it to undesirably curl into itself. Instead, the flexible substrate gives the veneer a flat rigid structure while upholding the flexibility of the composite material with the application of a force.

The flexible substrate 8 serves an additional purpose with respect to the veneer 7. The veneer 7 is thin enough so that it maintains flexibility, but, in certain examples, this thinness may allow for liquid or food secretions to leak through the first side of the veneer 7 and out through the second side of the veneer 7. The flexible substrate 8 can help serve as a sealant such that if any liquid, food secretions or similar do soak through the veneer 7, the flexible substrate 8 will inhibit the liquid, food secretions or similar from contacting the surface on which the cutting board rests. The flexible substrate 8 can also prevent the composite material cutting board from the potential safety hazard of sliding around during use.

In certain examples, the composite material including at least the veneer 7 and the flexible substrate 8 can be flexible in all directions, concave and convex, such that neither the veneer 7 nor the flexible substrate 8 will crack or separate from each other. The cutting board example can bend up to 180 degrees with a bending arc diameter of an inch or larger. The bend can be reached without the cracking of the veneer or delamination of the separate layers. The flexibility of the cutting board can be varied by the composition of the veneer 7 and/or the flexible substrate 8, in part measured by the durometer of the materials, as well as the thickness of the veneer 7 and/or the flexible substrate 8.

The flexible properties of the composite material can allow a cutting board implemented using the composite material to flex such that whatever material, whether it be food or not, is resting on the cutting board, can be funneled to allow for easy pouring, dumping, or similar of a material, vegetables, fruit, meat, nuts, etc., into a receptacle. Depending on the durometer and thickness of the composite material, the composite material can be rolled in addition to flexing and bending. While also being able to funnel food by use of the cutting board, the cutting board can bend and conform to the shape and size of a sink. This flexibility of the composite material allows for ease of cleaning, improving both convenience and health safety. The flexible properties of the composite materials also allow for convenient storage allowing the cutting board to conform to tight and irregular spaces while not causing permanent flexural damage.

The shape of the cutting board can vary in size and can be cut in various shapes. The shape and size of the veneer 1 and the flexible substrate 3 can decided by a laser cut, die cut, hand cut, computerized numerical control (CNC) knife cut, etc. The veneer 1 and the flexible substrate 3 may or may not be cut to the same size and shape. For example, the substrate 3 and veneer 1 can be cut to different shapes and/or sizes to create a juice trough to collect excess liquid from meet being chopped, etc., to create a flexible trough for collection of cut items such as a temporary storage for diced onions while another food item is cut, to form a utensil holder, etc.

Composite Material Examples with Flexible Veneer, Adhesive, and Flexible Substrate

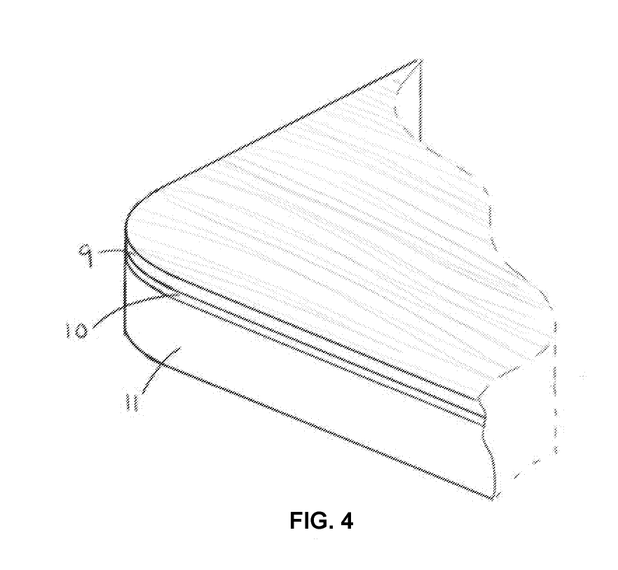

FIG. 4 illustrates an example of the invention. In this example, the veneer 9 is coupled to the flexible substrate 11 by means of an adhesive 10. The flexible substrate 11, as shown, can range in composition and thickness. Although FIG. 4 may not be shown to scale and the different layers may be illustrated to the correct ratio, FIG. 4 properly shows that the flexible substrate 11 can range in thickness. Despite the increased thickness of the flexible substrate 11, the composite material maintains flexibility up to a 180 degree bend with a bending arc diameter as small as an inch. This flex, without causing delamination or cracking of the veneer, allows for the composite material to bend in every direction and to be rolled, depending on the thickness of the veneer 9 and the flexible substrate 11.

The adhesive 10 can be used to couple the veneer 9 and the flexible substrate 11. The adhesive 10 binds the veneer 9 and flexible substrate 11 such that when the composite material is bent the veneer 9 and the flexible substrate 11 do not delaminate, crack, or fail. Complete lamination, aided by the adhesive, ensures that a seam between the veneer and the substrate does not split apart, for example. The adhesive can be flexible so as not to limit the flexibility of the composite material. The adhesive may be selected as determined by the flexible substrate being used and can include wood glue, contact adhesive (e.g., ethylene-vinyl acetate (EVA), other hot melt adhesive, etc.), silicone adhesive (e.g., 3M 9505™, etc.), synthetic adhesive (e.g., a porous synthetic adhesive such as an EVA contact adhesive, etc.), etc.

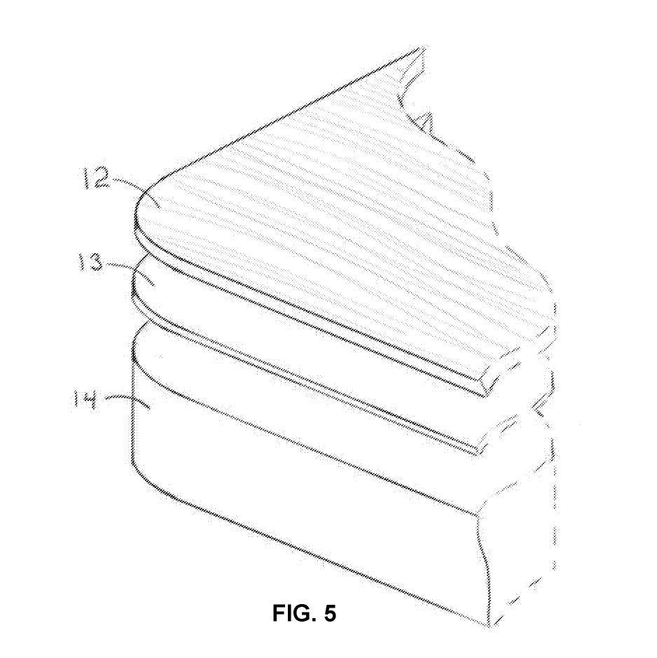

FIG. 5 illustrates an enlarged view of composite material. The veneer 12, the adhesive 13, and the flexible substrate 14 are shown. The three different materials come together to form the composite material for the cutting board, the invention.

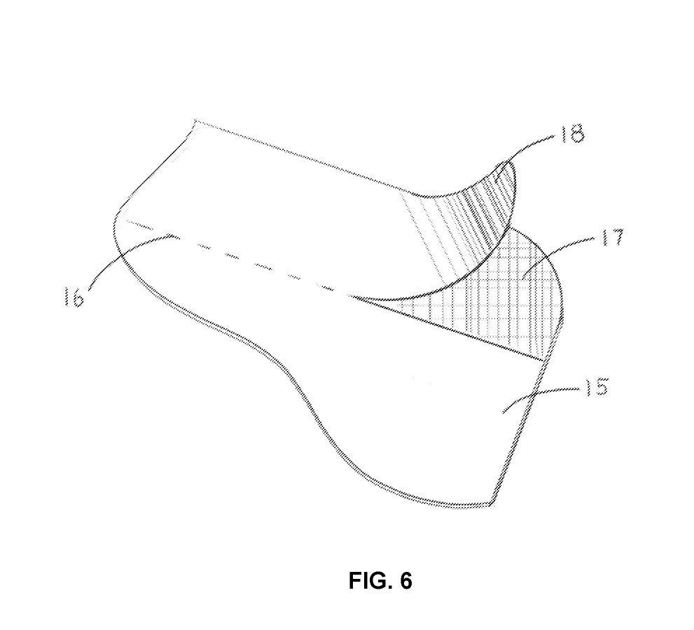

FIG. 6 illustrates an example, similar to the example in FIG. 1, but including a layer with a release liner 15/18. The illustrated example of FIG. 6, showing the underside corner section of an example cutting board, includes a flexible veneer layer, not shown, along with a repositionable adhesive 17 and the release liner 15/18. The release liner 15/18 is meant to cover and protect the repositionable adhesive until it is ready for use by the consumer. This release liner can have sections that allow a user to remove a portion 18 of the release liner to control how much adhesive is exposed, for example. An example of this can include cutting a perforated line 16 or curve into the release liner before or after the release liner is applied to the veneer and adhesive assembly. The perforated cut 16 allows for the release liner 15/18 to be removed in sections 15, 18. The separation of sections 15, 18 of the release liner 15/18, made possible by the perforated cuts 16, allows the user to select between various degrees of adhesiveness. The more of the repositionable adhesive 17 that the user selects to expose, the more the cutting board will stay stuck to a surface. In addition, a user can decide to remove a section of the release liner 15/18 now and keep other sections of the release liner 15/18 attached. This can preserve the adhesiveness of the unexposed sections of the repositionable layer 17, prolonging the life of the composite material cutting board. A post pressing or rolling process can then be used to remove air bubbles from the veneer, adhesive and release liner assembly. The release liner will easily be removed from the composite material exposing the repositionable adhesive 17 for use. The veneer and adhesive assembly can then be laser cut, die cut or similar to cut the sheet into a given shape and size. A release liner 6 & 15 can be applied before the veneer and the adhesive are shaped. The release liner 6 & 15 can be shaped separately and then applied to the veneer adhesive assembly with the use of a jig or other manual or automated process using a registration system such as optical or physical registration marks or features. The adhesive also acts as a seal to the natural veneer by inhibiting or eliminating the flow of liquid through it. An example use case of this sealing purpose would be to block food liquids or juices from seeping through the veneer onto the surface it has been adhered to. The benefit of this is to limit the propagation of a potential liquid mess and to prevent the liquid from reducing the effectiveness of the adhesive.

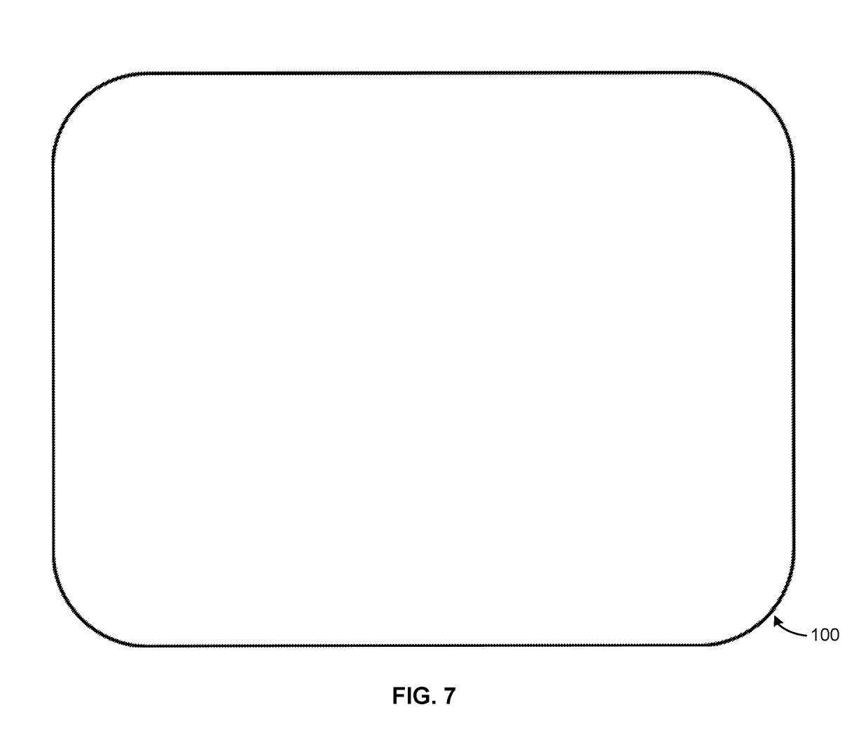

FIG. 7 illustrates an aerial view of an example composite material. The illustrated example shows the first layer, the veneer, cut to a specific shape to be used as a cutting board. Not pictured in the illustration is the third layer, comprised of the flexible substrate, or the adhesive, coupling the two layers. As shown in the illustration, the composite material cutting board is rigid and flat. The flexible substrate gives the cutting board structure and prevents the veneer from curling into itself. The flexible substrate can still allow, with the application of a force, the entire composite material cutting board to bend and flex.

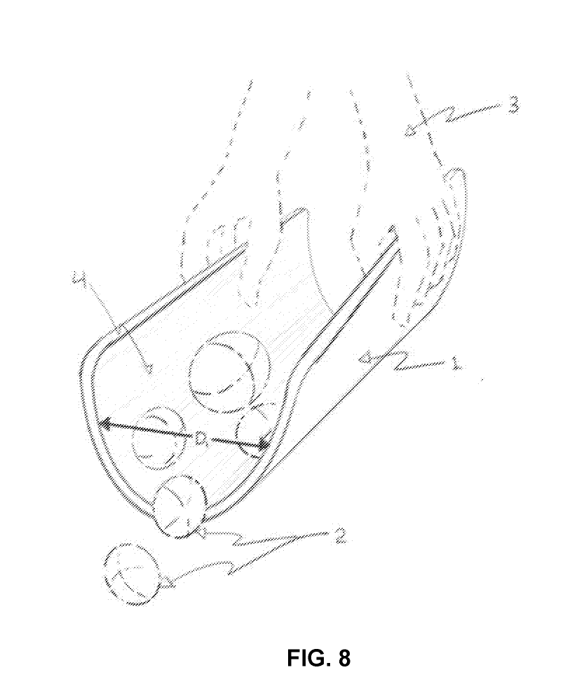

FIG. 8 illustrates an example of the composite material cutting board, including a natural veneer 4 and a flexible substrate 1, bending and flexing, with the application of a force 3, in such a way that allows cut food 2 to be poured or funneled into a receptacle, pan, pot, etc. The composite material cutting board can be bent and flexed up to 180 degrees around an arc with a diameter D1 of one inch. The flexibility of the cutting board can also be utilized so that the cutting board can conform to a storage location it may not have otherwise fit comfortably. Similarly, the composite material cutting board can conform to a small sink for more convenient cleaning.

Certain examples can include additional layers, in varying order, while exhibiting the same flexible behavior of prior examples. For example, a certain example can include a first flexible substrate coupled on one side to a second flexible substrate using an adhesive layer, wherein a second side of the second substrate is also coupled to a veneer, using another adhesive layer. More specifically, an example composite material, such as used to implement a cutting board, includes a silicone rubber layer connected via a first adhesive layer to a spring steel layer, which is connected via a second adhesive layer to a natural veneer layer. The example composite material provides a particular bending property such as providing a sheet steel inner layer to allow the cutting board to be bent and hold its shape until unbent, etc. A combination of different durometers of substrate can allow for a “springy” feel to the cutting board and/or create a memory of physical shape, for example. This example composite material can still flex up to 180 degrees around a bending arc diameter as small as one inch, for example. Another example composite material includes an aluminum layer attached via a first adhesive layer to a non-woven material layer, which is attached via a second adhesive layer to a natural veneer layer.

In certain examples, the composite material including the veneer, the flexible substrate, and the adhesive can be adjusted to fulfill other market needs besides that of the cutting board. For example, the composite material can be shaped and designed into a carrying bag. The bag will be both rigid to preserve its shape, but also remain flexible to bend and flex when needed. The flexibility of the composite material can allow for a bend or flex, up to 180 degrees, that can be utilized to create a variety of shapes. The veneer first layer can create a unique look that is both durable and polished. In addition, a carrying bag comprised of the composite material can create a water resistant bag, allowing usage in a variety of environments. In a similar fashion, a purse or handbag can be made of the composite material.

For example, a bag and/or other container can be formed from the composite material in a three-dimensional shape having 2, 3, 4, or more sides. In some examples, one continuous piece of composite material can form two or more sides of the bag by bending 90-180 degrees in a bending circumference with a diameter between 0.5 inch and 6 inches, with larger diameters corresponding to larger bends (e.g., larger diameters corresponding to 180 degree bends). Other materials, such as wood laminate flooring, cannot be manipulated and used in this way.

This flexible, durable veneer composite has a variety of uses. The initial use case for this new material is to provide a new type of cutting board that is both made of a natural material such as wood and flexes like a plastic cutting sheet. This composite material provides consumers with the desired ability to cut on a natural veneer cutting board while allowing them to easily pick up this cutting board, bend or flex this board and easily pour the food contents into a receptacle such as a pot or pan. In addition, this flexible durable veneer composite used as a cutting board and cut into a large shape similar to large solid wood cutting boards allows the user to easily clean it in a typical kitchen sink as it will bend and conform to the sink unlike large rigid solid wood or plastic cutting board. Other uses can be as temporary or semi-permanent removable surface coverings such as outdoor or older furniture, placemats etc. This composite can also be used as a building material for soft goods creating new soft wooden bags, purses, containers clothing etc. Other uses of this disposable veneer composite sheet could be to semi-permanently or temporarily cover flat or curved surfaces with a natural or wood veneer to obtain a natural wood look without the need to permanently apply a veneer to a surface as is normally done with wood veneers on furniture.

Example Methods of Manufacture

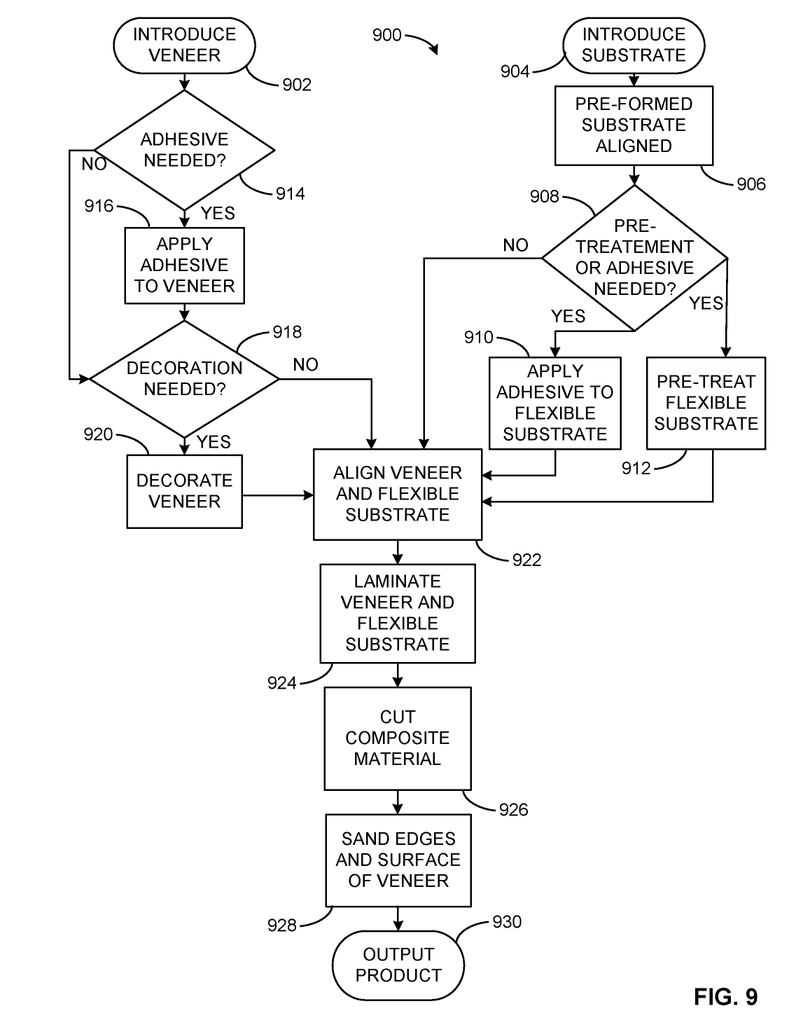

FIG. 9 illustrates a flow diagram of an example method of manufacturing 900. First, the veneer 24 (block 902) and the flexible substrate 29 (block 904) are introduced. To manufacture the composite material, the flexible substrate can be pre-formed into a specific shape and aligned for treatment (block 906). The flexible substrate can be any flexible material including a natural rubber, synthetic rubber, leather, plastic fabric, natural fabric, flexible metal, non-woven fabric, etc. The shape of the flexible substrate can vary depending on the desired end shape of the composite material. The substrate can be placed in an alignment nest to align the flexible substrate for further treatment (block 906).

At block 908, the flexible substrate can be pre-treated. For example, depending on the material selected, the flexible substrate can be pre-treated (block 910) to bind to adhesive properly to the substrate. Alternatively or in addition, at block 912, the flexible substrate (e.g., silicone, polyethylene, polypropylene, etc.) can be flame treated or corona treated (e.g., via a ribbon burner on a conveyor, etc.). Whether or not the flexible substrate is pre-treated (block 912), the adhesive can be applied (block 910) with a spray, roll, or other coating method of liquid or sheet adhesive, for example.

At block 914, the veneer can be processed to determine whether (e.g., according to a configuration) an adhesive is to be applied to the veneer. If so, then, at block 916, the adhesive is applied a side of the veneer. Thus, the adhesive can then be applied to either one or both of the second side of the veneer (block 916) and/or the first side of the flexible substrate 910. In certain examples, the veneer can already have an adhesive applied to its second side. This adhesive can be any adhesive that is flexible to some degree including wood glue, contact adhesive, silicone adhesive, etc. Prior to coupling of the veneer and the flexible substrate, the process 900 can determine whether decoration is to be applied (block 918). If so, the veneer can be decorated (block 918) with a logo, design, or similar. The veneer and the flexible substrate can then be aligned (block 922) and pressed together with a force. If application, a lamination process (block 924) can be used to laminate and remove air bubbles between the veneer and the flexible substrate. The lamination process (block 924) can also be used to activate the adhesive, for example. The lamination process (block 924) can be achieved through various methods including that of roller lamination or vacuum lamination, for example. The resulting composite material can be cut (block 926) using a laser, a die cutting machine, a clicker press, or a similar cutting device. The cutting device can be used to cut (block 926) the composite material to a desired specific shape.

In certain examples, the veneer can be cut using a method of laser, die, hand, or similar after being pressed together with the flexible substrate. The flexible substrate can be cut to the same shape as the veneer. After the veneer and the flexible substrate have been coupled by an adhesive and cut (block 926) by to specific shapes, the edges and the surface of the veneer can be smoothed out by sanding and/or routing (block 928). For example, an edge sander can be used to sand the edges of the composite material 100. After assembly, the composite material cutting board can be output (block 930) for distribution. The output (block 930) can include cleaning (e.g., to remove dust and other particulates as well as disinfect or sanitize the material 100 so that it is ready for use as a cutting board, etc.), packaging, labeling, etc.

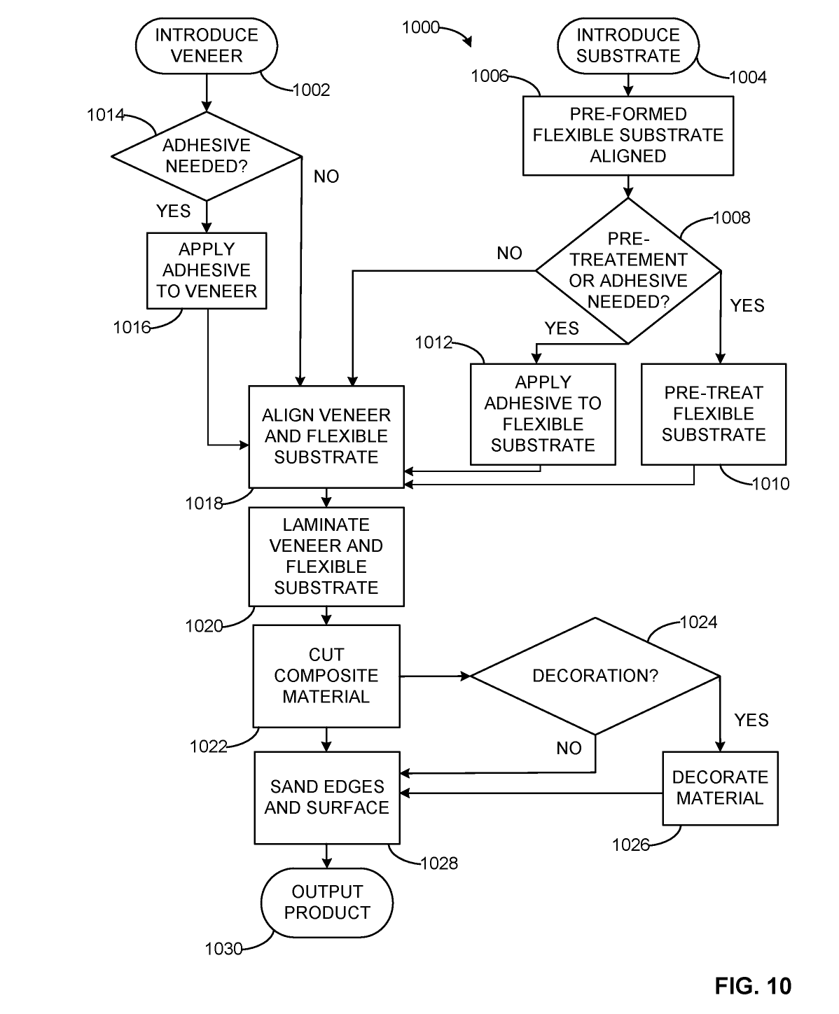

FIG. 10 illustrates a flowchart of an alternative example method 1000 of manufacturing, which begins at blocks 1002 and 1004 by introducing two large sheets of veneer (block 1002) and flexible substrate (block 1004). The flexible substrate is aligned (e.g., in an alignment nest, etc.) for further processing (block 1006). In this manufacturing example, depending on the selected material, a large sheet of flexible substrate can be pre-treated (block 1008) to bind to the adhesive properly. For example, flexible substrates such as silicone or polyethylene can be flame treated or corona treated such as using a ribbon burner (block 1010). Whether or not the flexible substrate is pre-treated (block 1010), an adhesive can be applied (block 1012) with a spray, roll, or other coating method of liquid or sheet adhesive. At block 1014, the veneer and/or a manufacturing process configuration is evaluated to determine whether adhesive is to be applied to the veneer. If so, at block 1016, adhesive is applied to the veneer. The adhesive can then be applied to either one or both of the second side of the veneer (block 1016) and/or the first side of the flexible substrate (block 1012). In certain examples, the veneer may already have an adhesive applied to its second side. The two layers can be properly registered or aligned (block 1018) using an assembly jig and/or other positioning device. The veneer and the flexible substrate can then be pressed together with a force. For example, a lamination process (block 1020) can be used to remove air bubbles between the veneer and the flexible substrate. The lamination process (block 1020) can also be used to activate the adhesive. The lamination process (block 1020) can be achieved through various methods including that of roller lamination or vacuum lamination. The resulting composite material can be cut (block 1022) using a laser, die, clicker press, or other similar cutting device. The method used to cut (block 1022) the composite material shapes the material to a desired specific shape, for example. Multiple composite material cutting boards can be cut (block 1022) out of the coupled sheets of veneer and flexible substrate. After the veneer and the flexible substrate have been coupled by an adhesive and cut to specific shapes, certain examples evaluate (block 1024) whether decoration is to be applied to the composite material 100. If so, then, at block 1026, one or more surfaces of the composite material can be decorated with a logo, brand information, design, etc. Next, the edges and the surface of the composite material can be sanded, routed, and/or otherwise smoothed (block 1028). After assembly, the composite material product (e.g., cutting board, etc.) is output (block 1030) and can be sent for distribution. In certain examples, the output (block 1030) includes cleaning (e.g., to disinfect or sterilize the material 100 so that it is ready for use as a cutting board, etc.), packaging, labeling, etc.

In certain examples, the veneer is coupled with the sealant. The flexible veneer can be cut by a method of laser, die, hand, or a similar cut. The method used to cut the veneer, shapes it to a desired specific shape. The first side of the veneer can be used to cut and serve food. Next, the sealant can be painted, spread, molded, sprayed, or similar, onto the second side of the veneer. In a certain example, the repositionable adhesive is coupled with the veneer. The flexible veneer can be cut by a method of laser, die, hand, or a similar cut. The method used to cut the veneer, shapes it to a desired specific shape. The first side of the veneer can be used to cut and serve food. Next, the repositionable adhesive can be painted, spread, molded, sprayed, or similar, onto the second side of the veneer. In certain examples, similar to those comprised of the veneer and repositionable adhesive, a third layer is comprised of a paper, or non-paper, release liner. The release liner can be cut by a method of laser, die, hand, or a similar cut. The release liner can be cut with perforated lines to create sections on the release liner. The release liner can be pressed and coupled to the exposed side of the repositionable adhesive. Several steps in the manufacturing process can be omitted or reordered.

In certain examples, the veneer includes a wood, bamboo, or palm leaf. The veneer can include a narrow grain natural hardwood such as a walnut, oak, teak, mahogany, etc. Wide grain woods, such as maple, can be more prone to cracking and are not desirable to be used as the veneer layer. Additionally, the veneer can be pre-stressed or pre-bent before being coupled with the flexible substrate. The pre-stressing of the veneer prepares the veneer so that it can be more flexible and able to endure increased stress of bending once coupled with the flexible substrate.

The flexible substrate can include a variety of materials. For example, the flexible substrate can be a flexible metal including spring steel, thin steel, aluminum, etc. On the other hand, the flexible substrate can include a synthetic rubber such as silicone. Example plastic based fabrics, including nylon and polyester, can also be selected as the flexible substrate. Other options include natural fabrics such as cotton. Because the first layer includes a natural veneer, the flexible substrate largely decides the selection of the adhesive in order to best bind the veneer and the substrate securely.

The veneer and substrate may need to be considered carefully in order to allow the composite material to bend 180 degrees while the bending arc diameter is as small as an inch. The wood veneer may not be thinner than 0.01 inches without the risk of a knife cutting through the wood, for example. The wood veneer may not be thicker than 0.075 inches without significantly restricting the flexibility of the composite material, for example.

If the flexible substrate is a flexible non-metal substrate, for example, some example durometer/thickness properties can be defined in Table 1:

TABLE 1

| Durometer | Thickness |
|---|---|
| 10-40 Shore 00 | ½ inch-1 inch thick |
| 40-80 Shore 00 | ¼ inch-½ inch thick |
| 30-60 Shore A | ⅛ inch-¼ inch thick |
| 60-90 Shore A | 0.001 inch-⅛ inch thick |

If the flexible substrate is a flexible metal substrate, for example, some example durometer/thickness properties can be defined in Table 2:

TABLE 2

| Substance | Thickness |
|---|---|
| Spring Steel | 0.0005 inch-0.002 inch thick |
| Mild Steel | 0.0005 inch-0.005 inch thick |
| Aluminum | 0.0005 inch-0.005 inch thick |

Coupling the pre-stressed veneer with a flexible substrate that exhibits a durometer and a corresponding thickness, using the specifications stated above, allows for the composite material to bend up to 180 degrees around an arc with a diameter of an inch, for example. This angle and sharpness of bend can be reached without the cracking of the veneer or delamination of the composite material.

While certain example methods 900, 1000 manufacturing the composite material are disclosed and described above, one or more of the elements, processes and/or devices illustrated in FIGS. 9-10 can be combined, divided, re-arranged, omitted, eliminated and/or implemented in any other way.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C.

From the foregoing, it will be appreciated that example methods, apparatus and articles of manufacture have been disclosed that provide a new composite material that can be used as a cutting board, folded into flexible articles of fashion such as bags, belts, ties, etc. The disclosed methods, apparatus and articles of manufacture improve existing cutting boards by providing flexibility, ease of cleaning, resistance to cutting, resistance to leakage, resistance to sliding, and other benefits and improvements described above with respect to prior approaches.

Unlike wood flooring, which is not designed to, nor will it, bend to angles described herein, certain examples allow a wood laminate and/or other veneer to bend to a prescribed angle to be used as a flexible wood and/or other natural fiber material cutting board. Certain examples provide composite material cutting boards that facilitate food cutting, food transfer, ease of cleaning, ease of storage, and sustained re-use. Certain examples provide ergonomically beneficial, safe, health cutting, transporting, and eating surfaces.

A flexible cutting board allows a user to not be required to use a separate utensil or hold the board with only one hand. A flexible cutting board allows the user to pick up the cutting board with two hands lifting vertically and not cantilevering weight at the wrist. Holding the flexible board with two hands creates a natural curve and guide for food to be delivered to the receptacle with a high degree of accuracy and with no strain on wrists. In addition, a flexible cutting board of almost any size will bend to conform to almost any sized sink allowing the washing of the cutting board to be entirely contained in the sink, thereby reducing or eliminating excess water escaping from the sink.

To create a guide for food delivery to receptacles and to conform to almost any sink, the flexible cutting board is to bend to 180 degrees around a circumference of a circle of 1″ diameter without damage to the cutting board. Less bending may not create a proper guide for small food pieces to be transferred accurately to a receptacle, especially a small receptacle. Also, less bending will not allow the cutting board to conform to the corners of a sink where the wall of the sink meets the bottom of the sink. Certain examples allow such bending so that the cutting board is entirely contained within the sink during washing.

Wood veneer alone does not make a lasting usable cutting surface and would slide on a counter or other surface without resistance, and synthetic flexible cutting boards have been attempted without much success. However, no combination of natural fiber veneer with flexible substrate has previously been provided. People enjoy cutting on natural wood for luxury, reduction of damage to knives and because plastic boards have proven to harbor bacteria even after being washed in a dishwasher. Certain examples provide a flexible natural fiber material cutting board. Wood laminate flooring will not provide the same solution as it is not useful for sanitary cutting and cannot bend and/or otherwise flex as described above. Certain examples mate the veneer and the flexible substrate so that the veneer is forced to follow the natural curvature of the substrate, which protects the veneer from cracking when curved and/or otherwise bent.

Additionally, the substrate helps to hold the cutting board in place by providing friction or surface tension on a surface (e.g., a counter, sink, etc.) on or in which the cutting board rests. The substrate also provides some weight and heft to make the cutting board easier to use and more resistant to structural damage. Further, the substrate allows the natural fiber veneer to be washed, re-used, and re-washed without curling up and/or otherwise losing its shape from the moisture. Thus, the composite material cutting board can be curled for use but flattened for re-use in the same or different flat and/or curved position.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A composite material cutting board comprising:
a first layer including a flexible veneer made of a natural fiber material; and
a second layer including a flexible substrate, coupled to a first side of the first layer, wherein the second layer is to support the first layer to be resistant to cutting and to be bendable up to 180 degrees to obtain a curvature without damaging the first layer or the second layer.

2. A composite material cutting board as claimed in claim 1, further including a third layer positioned between the first layer and the second layer, the third layer including an adhesive to couple the veneer and the flexible substrate.

3. A composite material cutting board as claimed in claim 2, further including a fourth layer, the fourth layer including a repositionable adhesive applied to a second side of the second layer to removably adhere the composite material cutting board to a surface.

4. A composite material cutting board as claimed in claim 1, wherein the first layer and the second layer are laminated to fuse the first layer and the second layer.

5. A composite material cutting board as claimed in claim 1, wherein a flexibility of the composite material cutting board is based on a relationship between a durometer and a thickness of the second layer to enable the composite material to bend up to 180 degrees to obtain a curvature of one inch in diameter.

6. A composite material cutting board as claimed in claim 5, wherein, when the second layer includes a flexible, non-metal substrate, the durometer is between 10 Shore 00 and 90 Shore A, and the thickness is between 0.001 inch and 1 inch.

7. A composite material cutting board as claimed in claim 5, wherein, when the second layer includes a flexible metal substrate, the thickness is between 0.0005 inch and 0.005 inch.

8. A composite material cutting board as claimed in claim 1, wherein a shape of the first layer does not match a shape of the second layer.

9. A composite material cutting board as claimed in claim 1, wherein the natural fiber material of the first layer is to include at least one of wood, bamboo, or palm leaf, and wherein the flexible substrate of the second layer is to include an elastomeric rubber.

10. A method of manufacturing a composite material cutting board comprising only two layers, the two layers consisting of a first layer including a flexible veneer made of at least one of bamboo, wood, or palm leaf; and a second layer including a flexible substrate, coupled to a first side of the veneer, wherein the flexible substrate is an elastomeric rubber compound including at least one of silicone, nitrile or neoprene applied to the first layer, the method comprising:
forming the first layer into a first specified shape;
forming the second layer into a second specified shape;
registering the first layer and the second layer to align the first layer and the second layer in a first relative position; and
applying the second layer to the first layer to fuse the second layer with the first layer.

11. A method as claimed in claim 10, further including applying at least one of a post pressing or a rolling process to remove air bubbles between the first layer and the second layer.

12. A method as claimed in claim 10, further including applying an adhesive to at least one of the first layer or the second layer to adhere the first layer and the second layer.

13. A method as claimed in claim 12, wherein the adhesive is a pressure sensitive adhesive.

14. A method as claimed in claim 10, wherein a flexibility of the composite material cutting board is based on a durometer and thickness of the flexible substrate.

15. A method as claimed in claim 14, wherein the durometer and thickness of the flexible substrate enable the composite material cutting board to be rolled.

16. A method as claimed in claim 14, wherein the durometer and thickness of the flexible substrate enable the composite material cutting board to be bent into a shape including an opening through which a substance is to be poured from a surface of the composite material cutting board into a receptacle.

17. A method as claimed in claim 10, wherein the first layer and the second layer are formed via at least one of laser cutting or die cutting.

18. A method as claimed in claim 17, wherein the first specified shape is the same as the second specified shape.

19. A method as claimed in claim 10, wherein a density of the second layer allows for pressure to be applied to the first layer without flexural damage to the first layer.

20. A composite material cutting board comprising:
a first layer including a flexible veneer made of at least one of bamboo, wood, or palm leaf;
a second layer including a flexible substrate, coupled to a first side of the veneer, wherein the flexible substrate is an elastomeric rubber compound including at least one of silicone, nitrile or neoprene applied to the first layer; and
a third layer, the third layer including an adhesive, to couple the first layer and the second layer,
wherein a thickness and at least one of a durometer or an elasticity of the second layer enables the second layer to bend and support the first layer and third layer in bending without damaging any of the first layer, the second layer, or the third layer.
